(19) United States
(12) Patent Application Publication
(10) Pub. No.: US 2025/0147302 A1
(43) Pub. Date: May 8, 2025

(54) Compact scanners

(71) Applicant: Lyte AI Inc., Mountain View, CA (US)

(72) Inventor: Jamie Nam, Los Altos, CA (US)

(21) Appl. No.: 18/931,113

(22) Filed: Oct. 30, 2024

Related U.S. Application Data
(60) Provisional application No. 63/596,314, filed on Nov. 6, 2023.
(60) Provisional application No. 63/574,260, filed on Apr. 4, 2024.

(51) Int. Cl. G02B 26/10; G02B 7/182

(52) U.S. Cl. CPC G02B 26/105; G02B 7/1821

(57) ABSTRACT

An optical scanner includes a mirror, which has a reflective front surface and a rear surface) and is mounted to rotate about a mirror axis. A motor is mounted behind the mirror in proximity to the rear surface and has a rotating shaft, which rotates about a shaft axis parallel to the mirror axis. A mechanical drive is coupled between the rotating shaft and the mirror so as to cause the mirror to oscillate about the mirror axis responsively to rotation of the shaft.

### CROSS-REFERENCE TO RELATED APPLICATIONS

This application claims the benefit of U.S. Provisional Patent Application 63/596,314, filed Nov. 6, 2023, and of U.S. Provisional Patent Application 63/574,260, filed Apr. 4, 2024. The disclosures of these related applications are incorporated herein by reference.

### FIELD

The present invention relates generally to optical devices, and particularly to scanning mirrors.

### BACKGROUND

Oscillating mirrors are used in a wide range of applications, for example to scan a beam of light across a target area or to scan the field of view of an optical sensor. Various mechanisms are known in the art for rotating a mirror. For example, the mirror may be mounted on a galvanometer, which shifts the mirror angle as a function of the applied voltage.

### SUMMARY

Embodiments of the present invention that are described herein provide improved optical scanners, as well as methods for their production and operation.

There is therefore provided, in accordance with an embodiment of the invention, an optical scanner, including a mirror, which has a reflective front surface and a rear surface and is mounted to rotate about a mirror axis. A motor is mounted behind the mirror in proximity to the rear surface and has a rotating shaft, which rotates about a shaft axis parallel to the mirror axis. A mechanical drive is coupled between the rotating shaft and the mirror so as to cause the mirror to oscillate about the mirror axis responsively to rotation of the shaft.

In some embodiments, the mechanical drive includes a linkage. In a disclosed embodiment, the linkage includes a motor arm connected to the shaft of the motor, a mirror arm connected to the mirror, and a linking arm connected to the motor arm and to the mirror arm by respective bearings.

Alternatively, the mechanical drive includes a cam connected to rotate with the shaft and a cam follower, which is connected to the mirror and rides on an outer surface of the cam as the cam rotates.

In some embodiments, the scanner includes, a motor controller, which is configured to vary a rotational speed of the motor as a function of an angle of oscillation of the mirror. In a disclosed embodiment, the scanner includes a sensor, which is coupled to sense an angle of rotation of a component of the scanner, wherein the motor controller is configured to control the motor responsively to an output of the sensor.

In a disclosed embodiment, the mechanical drive is configured to cause the mirror to oscillate about the mirror axis in a sawtooth scan pattern. Alternatively, the mechanical drive is configured to cause the mirror to oscillate about the mirror axis in a triangular scan pattern.

There is also provided, in accordance with an embodiment of the invention, an optical scanner, including a mirror, which is mounted to rotate about a mirror axis, and a cam, which is mounted to rotate about a cam axis. A motor is coupled to drive the cam to rotate about the cam axis. A cam follower is connected to the mirror and rides on an outer surface of the cam as the cam rotates, thereby causing the mirror to oscillate about the mirror axis.

In some embodiments, the scanner includes a spring, which is coupled between the mirror and the motor to maintain contact between the cam follower and the cam.

In some embodiments, the motor is mounted behind the mirror. In a disclosed embodiment, the cam follower is positioned behind the mirror.

In one embodiment, the cam has a non-symmetrical flattened side. Alternatively, the cam has a mirror-image symmetry in a plane containing the cam axis.

There is additionally provided, in accordance with an embodiment of the invention, a method for scanning, which includes mounting a mirror, which has a reflective front surface, to rotate about a mirror axis. A motor, having a rotating shaft, which rotates about a shaft axis, is mounted behind the mirror in proximity to a rear surface with the shaft axis parallel to the mirror axis. A mechanical drive is coupled between the rotating shaft and the mirror so as to cause the mirror to oscillate about the mirror axis responsively to rotation of the shaft.

The present invention will be more fully understood from the following detailed description of the embodiments thereof, taken together with the drawings in which:

### BRIEF DESCRIPTION OF THE DRAWINGS

FIGS. 1A, 1B and C are schematic pictorial illustrations of a cam-based scanner at three different angles of rotation during a scan, in accordance with an embodiment of the invention;

FIG. 2 is a schematic top view of a cam, along with the shifting position of a cam follower as the cam rotates through a full cycle, in accordance with an embodiment of the invention;

FIG. 3 is a schematic top view of a cam, along with the shifting position of a cam follower as the cam rotates through a full cycle, in accordance with another embodiment of the invention;

FIGS. 4A and 4B are schematic pictorial illustrations of a cam-based scanner seen from above and below, respectively, in accordance with another embodiment of the invention;

FIGS. 5A and 5B are schematic pictorial illustrations of a linkage-based scanner at two different angles of rotation, in accordance with an embodiment of the invention; and

FIG. 6 is a schematic bottom view of the scanner shown in FIGS. 5A and 5B.

### DETAILED DESCRIPTION

### Overview

Embodiments of the present invention that are described here provide novel, compact optical scanner designs, in which a mirror is driven to oscillate about a mirror axis by rotation of the shaft of a motor about a shaft axis, parallel to (but not collinear with) the mirror axis. The motor is mounted behind the mirror, in proximity to the rear, non-reflective surface of the mirror. The term “behind” means that a geometrical projection of the planar area of the mirror onto the shaft axis of the motor will cover at least a part of the cross-sectional area of the motor in the plane of the projection. In the embodiments that are described below, this geometrical projection covers most or all of the cross-sectional area of the motor. Placing the motor behind the mirror in this manner is advantageous in reducing the overall transverse dimensions (height and width) of the scanner.

A mechanical drive is coupled between the rotating shaft of the motor and the mirror so as to cause the mirror to oscillate about the mirror axis in response to the rotation of the shaft. In some embodiments, the mechanical drive comprises a linkage, which converts the rotational motion of the motor to the oscillation of the mirror. This drive arrangement is useful in reducing the torque and power that are needed to drive the mirror. The lengths and configuration of the links in the linkage determine the scan profile and scan range.

In other embodiments, the mechanical drive comprises a cam, rotating continuously on the shaft of the motor. A cam follower, connected to the mirror, rotates against the cam and thus causes the mirror to oscillate through an angular range that is determined by the geometry of the cam, the cam follower, and the mirror. The shape of the cam determines the scan profile and scan range. Cam designs for sawtooth (unidirectional) and triangular (bidirectional) scans are shown below by way of example.

In the present embodiments, the mechanical drive enables the motor to drive the oscillatory motion of the mirror while the motor shaft rotates continuously in a single direction. This arrangement tends to reduce the power consumption of the motor, relative to schemes in which the motor must continually switch directions. The scan rate of the oscillating mirror can be adjusted simply by changing the motor speed. The motor may be operated at a constant speed during the scan. Alternatively, the motor speed may be varied during a scan, for example to maintain a constant angular scan rate or to cause the mirror to oscillate more slowly over a certain angular range of interest, so that denser scan data can be collected within this range.

The term “mirror axis,” as used in the present description and in the claims, refers to the axis of rotation around which the mirror oscillates, for example an axis passing through the centers of the bearings on which the mirror (or a gimbal holding the mirror) is mounted. Although the mirror axis passes through the mirror in the examples that are shown in the figures, in alternative embodiments the mirror axis may be located behind or in front of the mirror.

Scanners in accordance with the present embodiments are compact, robust, power-efficient, and inexpensive. Techniques of automotive cam and linkage design and production can be used for longevity. A rotational sensor, such as an optical encoder, can be coupled to the motor shaft, the mechanical drive, or the mirror itself for purposes of scan calibration and closed-loop control.

### Cam-Based Scanners

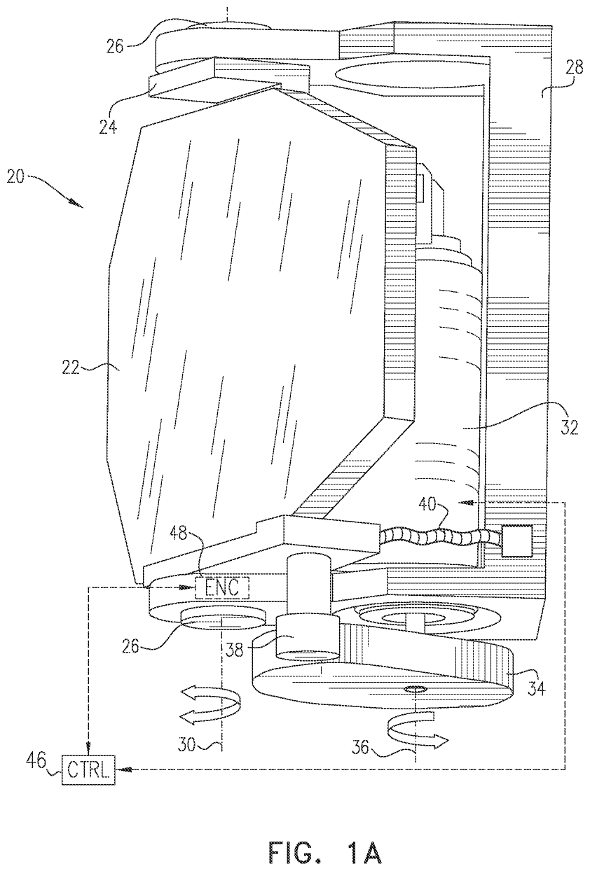

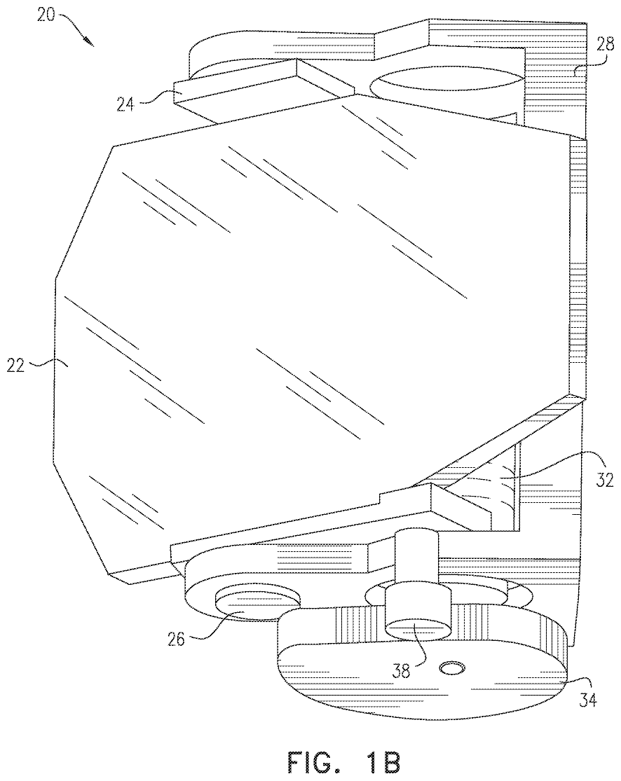

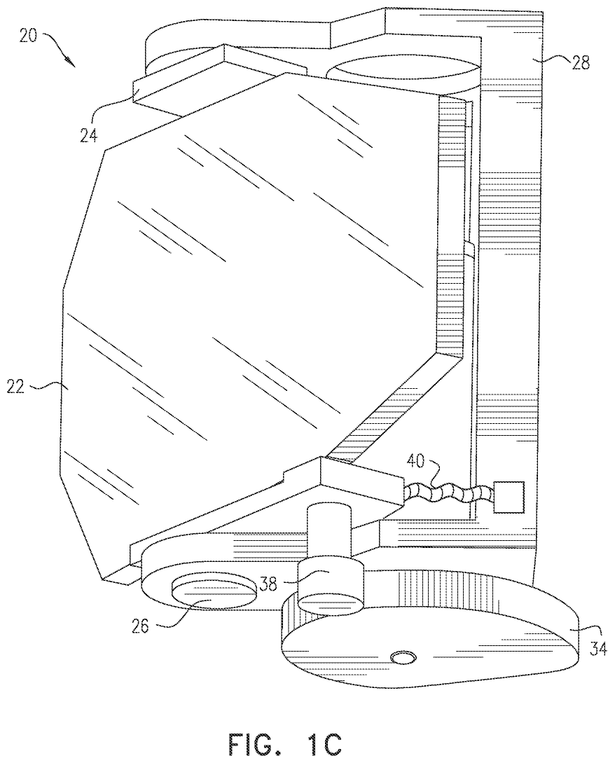

FIGS. 1A, and are schematic pictorial 1B 1C illustrations of a cam-based scanner 20 at three different angles of rotation during a scan, in accordance with an embodiment of the invention. Scanner 20 comprises a front-surface mirror 22, held by a gimbal 24, which rotates on bearings 26 about a mirror axis 30 relative to a stationary frame 28. A motor 32, which is mounted on frame 28 behind mirror 22, drives a cam 34 to rotate continuously about a cam axis 36, which is parallel to mirror axis 30. A cam follower 38, attached to gimbal 24, rotates against the surface of cam 34 and thus translates the rotational motion of the cam into the back-and-forth oscillatory motion of mirror 22 about mirror axis 30. A spring 40 between mirror 22 and motor 32 (in this case coupled between gimbal 24 and frame 28) maintains constant contact between cam follower 38 and cam 34. Thus, rotation of cam 34 through a full 360° cycle causes mirror 22 to scan through the different angles shown in FIGS. 1A-C.

Optionally, a rotational sensor 48, such as an optical encoder, is coupled to mirror axis 30 and provides an output indicative of orientation angle of the mirror. Alternatively or additionally, a suitable sensor can be coupled to the shaft of motor 32 or to cam 34. A controller 46, such as a suitable microcontroller, receives and processes the output of rotational sensor 48 for the purpose of scan angle calibration and/or closed-loop control over the mirror scan speed. For the sake of simplicity, controller 46 and sensor 48 are shown only in FIG. 1A. Similar control and sensing arrangements may likewise be implemented, mutatis mutandis, in the other embodiments that are described below.

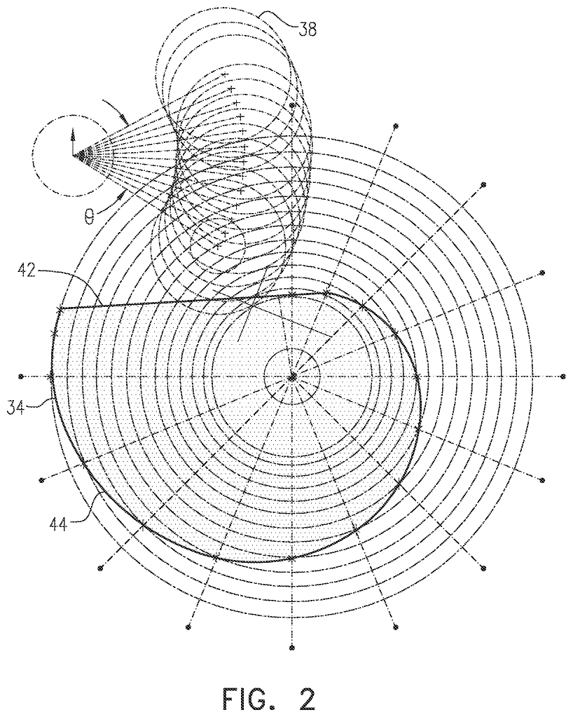

FIG. 2 is a schematic top view of cam 34, along with the shifting position of cam follower 38 as the cam rotates through a full cycle. Cam 34 is non-symmetrical, with one flattened side 42 and a curved surface 44 of gradually increasing radius opposite the flattened side. This cam profile causes mirror 22 to scan in a sawtooth pattern, with scan angle increasing gradually over an angular range θ as cam follower 38 rotates along curved surface 44. When cam follower 38 reaches flattened side 42, mirror 22 snaps back rapidly to the opposite end of the range due to the force exerted by spring 40. The pictured design gives a scan range of θ=60°, but larger or smaller scan ranges can be created by appropriate design of the cam and other scanner components.

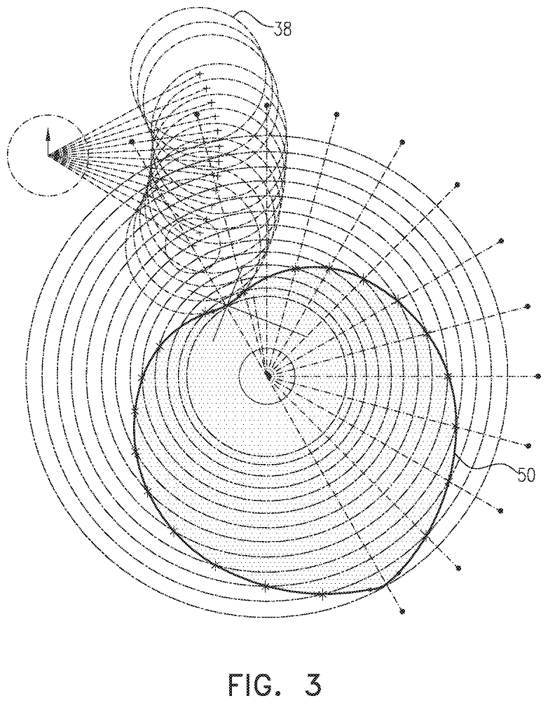

FIG. 3 is a schematic top view of a cam 50, which can be used in place of cam 34 in scanner 20, in accordance with another embodiment of the invention. In contrast to the asymmetrical design of cam 34, cam 50 has mirror-image symmetry in the plane of the cam axis, which will cause mirror 22 to scan back and forth over the scan range at an equal angular rate in both directions. Thus, mirror 22 will execute a bidirectional, triangular scan pattern, rather than the unidirectional sawtooth pattern induced by cam 34.

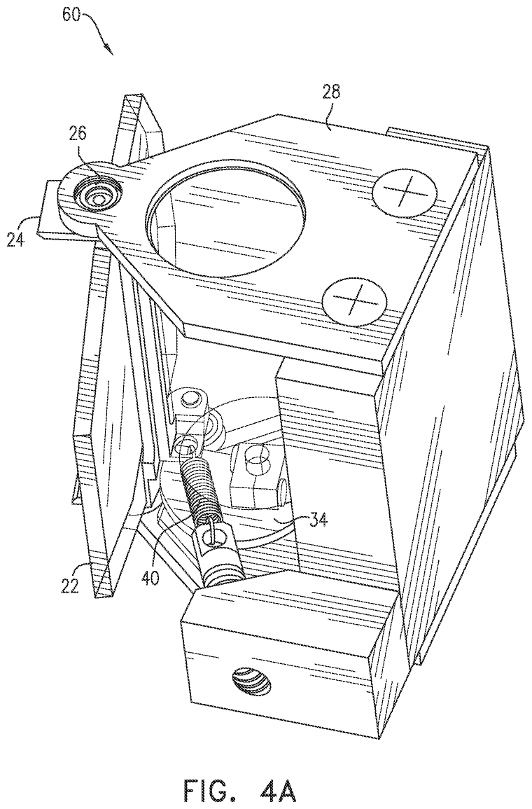

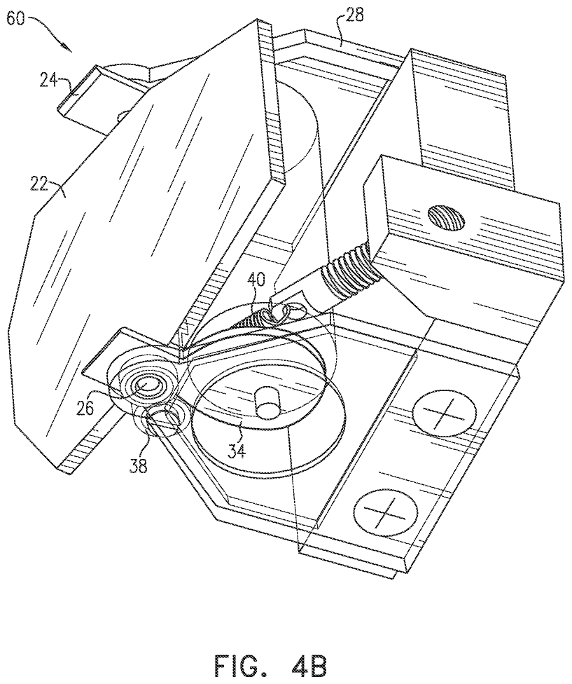

FIGS. 4A and 4B are schematic pictorial illustrations of a cam-based scanner 60 seen from above and below, respectively, in accordance with another embodiment of the invention. The components of scanner 60 are labeled with the same indicator numbers as the corresponding components of scanner 20 (FIGS. 1A-C), but motor 32 has been removed from scanner 60 to facilitate visualization of the other parts of the scanner.

Scanner 60 is similar in design and operation to scanner 20, except that in scanner 60, cam follower 38 is positioned behind mirror 22, rather than at the side of the mirror as in scanner 20. This design is advantageous in reducing the overall size of the scanner, and particularly in reducing the transverse dimensions, though it may restrict the angular range of the mirror oscillation. Alternatively, cam 34 may be positioned below mirror 22 for greater range flexibility.

Although the drawings described above show certain specific geometrical configurations of the mirror, cam, and cam follower, other configurations in which a rotating cam drives an oscillatory movement of a mirror will be apparent to those skilled in the art after reading the present disclosure and are within the scope of the present invention.

### Linkage-Based Scanners

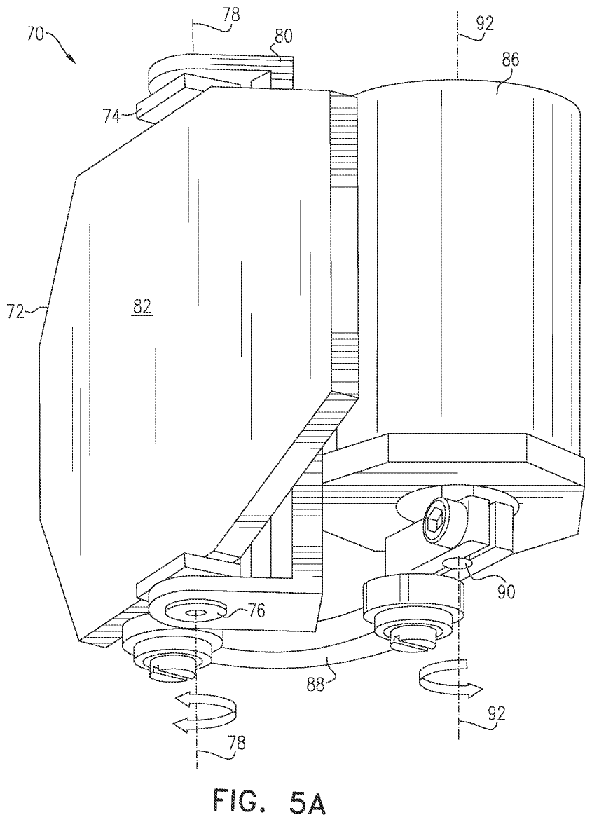

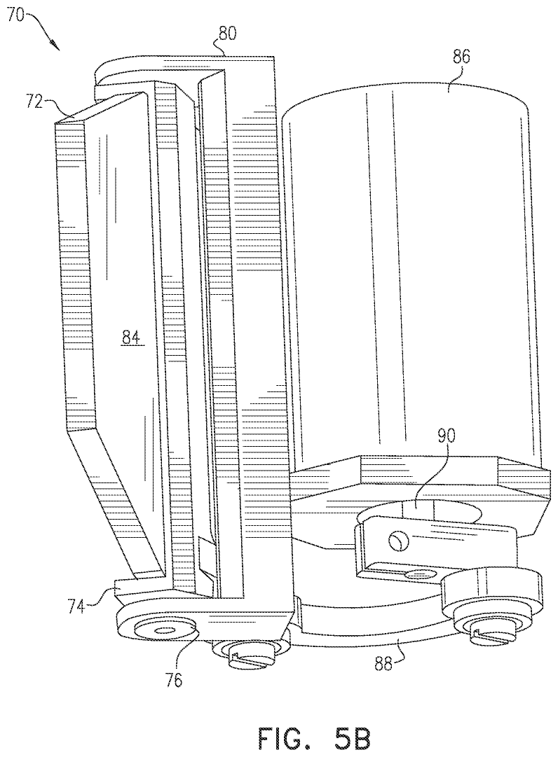

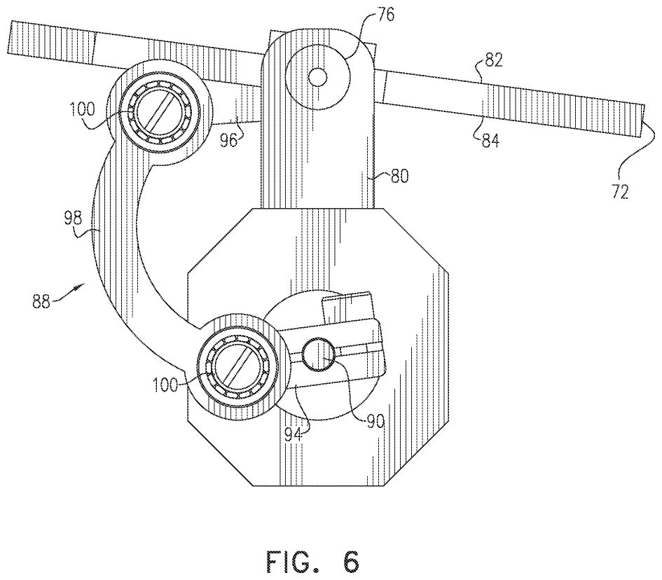

Reference is now made to FIGS. 5A, 5B and 6, which schematically illustrate a linkage-based scanner 70, in accordance with an embodiment of the invention. FIGS. 5A and 5B are pictorial views showing scanner 70 at two different angles of rotation during a scan, while FIG. 6 is a bottom view of the scanner.

Scanner 70 comprises a mirror 72, held by a gimbal 74, which rotates on bearings 76 about a mirror axis 80 relative to a stationary frame 78. Mirror 72 has a reflective front surface 82 and a rear surface 84 opposite the front surface. A motor 86 behind mirror 72, in proximity to rear surface 84, drives a linkage 88 to convert unidirectional rotational motion of a shaft 90 of motor 86, about a shaft axis 92, into back-and-forth oscillatory motion of mirror 72 about mirror axis 80. Shaft axis 92 is parallel to mirror axis 80. In contrast to the preceding cam-based embodiment, linkage 88 enables motor 86 to drive the oscillation of mirror 72 without the counterforce of a spring, thus reducing power consumption.

As can be seen in FIG. 6, linkage 88 comprises a motor arm 94 connected to shaft 90 of motor 86; a mirror arm 96 connected to mirror 72 (in this case via gimbal 74, which holds the mirror); and a linking arm 98 connected to arms 94 and 96 by bearings 100. The lengths of arms 94, 96 and 98 are chosen to give the desired angular scan range of mirror 72. For example, lengthening motor arm 94 will generally increase the scan range of the mirror.

Although the drawings described above show certain specific geometrical configurations of the mirror and linkage, other configurations in which the oscillatory movement of a mirror is driven by the rotating shaft of a motor situated behind the mirror will be apparent to those skilled in the art after reading the present disclosure and are within the scope of the present invention. Thus, the embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An optical scanner, comprising:
a mirror, which has a reflective front surface and a rear surface and is mounted to rotate about a mirror axis;
a motor, which is mounted behind the mirror in proximity to the rear surface and has a rotating shaft, which rotates about a shaft axis parallel to the mirror axis; and
a mechanical drive, which is coupled between the rotating shaft and the mirror so as to cause the mirror to oscillate about the mirror axis responsively to rotation of the shaft.

2. The scanner according to claim 1, wherein the mechanical drive comprises a linkage.

3. The scanner according to claim 2, wherein the linkage comprises:
a motor arm connected to the shaft of the motor;
a mirror arm connected to the mirror; and
a linking arm connected to the motor arm and to the mirror arm by respective bearings.

4. The scanner according to claim 1, wherein the mechanical drive comprises a cam connected to rotate with the shaft and a cam follower, which is connected to the mirror and rides on an outer surface of the cam as the cam rotates.

5. The scanner according to claim 1, and comprising a motor controller, which is configured to vary a rotational speed of the motor as a function of an angle of oscillation of the mirror.

6. The scanner according to claim 5, and comprising a sensor, which is coupled to sense an angle of rotation of a component of the scanner, wherein the motor controller is configured to control the motor responsively to an output of the sensor.

7. The scanner according to claim 1, wherein the mechanical drive is configured to cause the mirror to oscillate about the mirror axis in a sawtooth scan pattern.

8. The scanner according to claim 1, wherein the mechanical drive is configured to cause the mirror to oscillate about the mirror axis in a triangular scan pattern.

9. An optical scanner, comprising:
a mirror, which is mounted to rotate about a mirror axis;
a cam, which is mounted to rotate about a cam axis;
a motor, which is coupled to drive the cam to rotate about the cam axis; and
a cam follower, which is connected to the mirror and rides on an outer surface of the cam as the cam rotates, thereby causing the mirror to oscillate about the mirror axis.

10. The scanner according to claim 9, and comprising a spring, which is coupled between the mirror and the motor to maintain contact between the cam follower and the cam.

11. The scanner according to claim 9, wherein the motor is mounted behind the mirror.

12. The scanner according to claim 11, wherein the cam follower is positioned behind the mirror.

13. The scanner according to claim 9, wherein the cam has a non-symmetrical flattened side.

14. The scanner according to claim 9, wherein the cam has a mirror-image symmetry in a plane containing the cam axis.

15. A method for scanning, comprising:
mounting a mirror, which has a reflective front surface, to rotate about a mirror axis;
mounting a motor, having a rotating shaft, which rotates about a shaft axis, behind the mirror in proximity to a rear surface with the shaft axis parallel to the mirror axis; and
coupling a mechanical drive between the rotating shaft and the mirror so as to cause the mirror to oscillate about the mirror axis responsively to rotation of the shaft.

16. The method according to claim 15, wherein coupling the mechanical drive comprises coupling a linkage between the rotating shaft and the mirror.

17. The method according to claim 16, wherein coupling the linkage comprises:
connecting a motor arm to the shaft of the motor;
connecting a mirror arm to the mirror; and
connecting a linking arm to the motor arm and to the mirror arm by respective bearings.

18. The method according to claim 15, wherein coupling the mechanical drive comprises:
connecting a cam to rotate with the shaft;
connecting a cam follower to the mirror; and
positioning the cam follower to ride on an outer surface of the cam as the cam rotates.

19. The method according to claim 15, and comprising varying a rotational speed of the motor as a function of an angle of oscillation of the mirror.

20. The method according to claim 15, wherein coupling the mechanical drive causes the mirror to oscillate about the mirror axis in a sawtooth scan pattern.

21. The method according to claim 15, wherein coupling the mechanical drive causes the mirror to oscillate about the mirror axis in a triangular scan pattern.
